(19) United States
(12) Patent Application Publication
(10) Pub. No.: US 2008/0250032 A1
(43) Pub. Date: Oct. 9, 2008

(54) METHOD AND SYSTEM FOR EFFICIENTLY SAVING AND RETRIEVING VALUES OF A LARGE NUMBER OF RESOURCE VARIABLES USING A SMALL REPOSITORY

(75) Inventor: Martin M. Fullam, New Paltz, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/696,306

(22) Filed: Apr. 4, 2007

(51) Int. Cl. G06F 7/00

(52) U.S. Cl. 707/100

(57) ABSTRACT

Saving and retrieving operations of values of a large number of resource variables include creating and maintaining a small repository in an event monitoring software management application to track all resource variables and their state values and to record unique entries of resource variable identifiers, but only for those resources in a non-normal state, when only a small set of resources are expected to be in a non-normal state at any point in time, is conducted using a repository which is smaller than all of the possible resources to be monitored and recording the values by not recording RVIDs and their state values when their state values are normal, and recording RVIDs and their state values when their state values are non-normal, by recording only RVIDs and not their Boolean state values when their state values are non-normal.

### TECHNICAL FIELD

The present invention relates to computer data handling applications, where unlimited implementations in hardware, software or both are possible. More particularly, the present invention relates to efficiently saving and retrieving the Boolean values of a large number of resource variables, when most of the large number of resource variables are expected to have the same value at any point in time.

### BACKGROUND

Known methods and systems for recording large numbers of Boolean state values and their resource variable identifiers require large memory allocations, which increase costs and decrease performance of data handling solutions.

Therefore, the need exists for a data handling solution that can track the Boolean values of a large number of resource variables, reduce memory allocations and associated costs, while increasing overall performance of the data handling solution.

### SUMMARY OF THE INVENTION

A method and system are disclosed herein for efficiently saving and retrieving Boolean values of each one of a plurality of resource variables using a small repository (i.e., having a small physical size), for use in associated computer data handling systems and/or networks to monitor resource events. The method and system are most efficient when most resource variables have the same known ‘normal’ value, at any point in time. The method of saving Boolean values is accomplished by obtaining a resource variable identifier (RVID) and its associated Boolean value, determining whether the Boolean value is normal or non-normal, adding a RVID entry in memory if the RVID entry for the non-normal Boolean value does not exist and proceeding to a save operation return; or, if the RVID entry does exist, then the method of saving proceeds to the save operation return. In the alternative, if it is determined that the Boolean value is normal, then the RVID entry is removed from memory and the operation proceeds to the save operation return, if the RVID entry exists in memory for a normal Boolean value. Or, if the RVID does not exist in memory for the normal Boolean value, then the operation proceeds to the save operation return.

Next, the method of retrieving Boolean values is accomplished by obtaining a RVID, then determining whether an entry for the RVID exists in memory. If the entry for the RVID does not exist, then a set return value is set to the normal Boolean value and the operation proceeds to a retrieve operation return. In the alternative, if the entry for the RVID does exist in memory, then the set return value is set to the non-normal Boolean value and the operation proceeds to the retrieve operation return.

Thus, the useful, practical and concrete result of reducing the required memory allocation in the associated computer data handling systems and/or networks in which the efficient saving and retrieving method and system are implemented is accomplished because by inventive design the algorithms conducting the operations of the efficient saving and retrieving method and system cause the memory capacity of the small repository to be only as large as the sum of RVIDs with non-normal Boolean values. Also, memory capacity can be reduced further because the algorithms by design know that any RVIDs recorded each have the non-normal Boolean value of one and each of the rest have the normal Boolean value of zero; therefore, once it is determined by the algorithms whether the values are either normal or non-normal, it is not required to record any of the non-normal values and it is not required to record any of the normal values. In addition, the size of the small repository is kept small by pruning RVIDs with normal Boolean values, where the size of the small repository is measured in terms of memory capacity of repository entry locations.

The above-described and other features will be appreciated and understood by those skilled in the art from the following detailed description, drawings, and appended claims.

### DETAILED DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

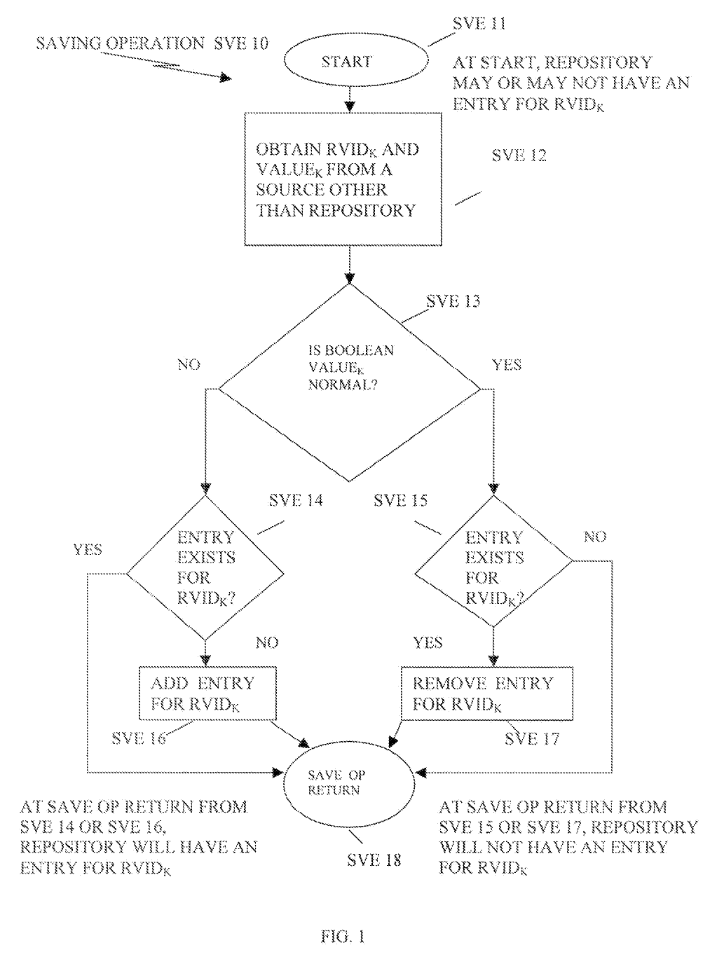

FIG. 1 illustrates an operation for carrying out a preferred embodiment of efficiently saving RVIDs and their associated Boolean values.

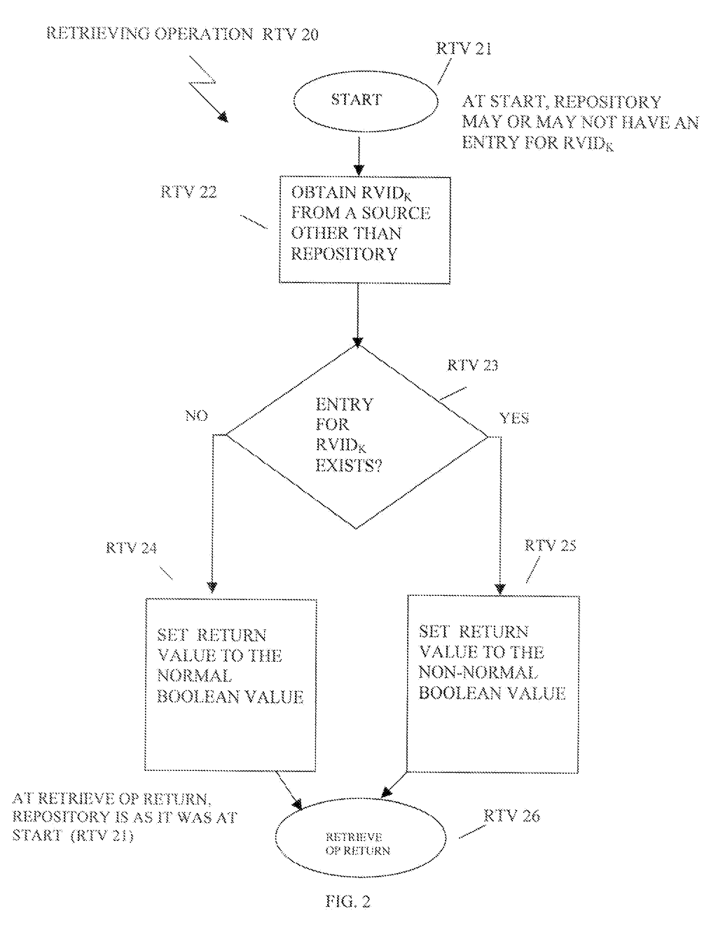

FIG. 2 illustrates an operation for carrying out the preferred embodiment of efficiently retrieving the Boolean state values of RVIDs.

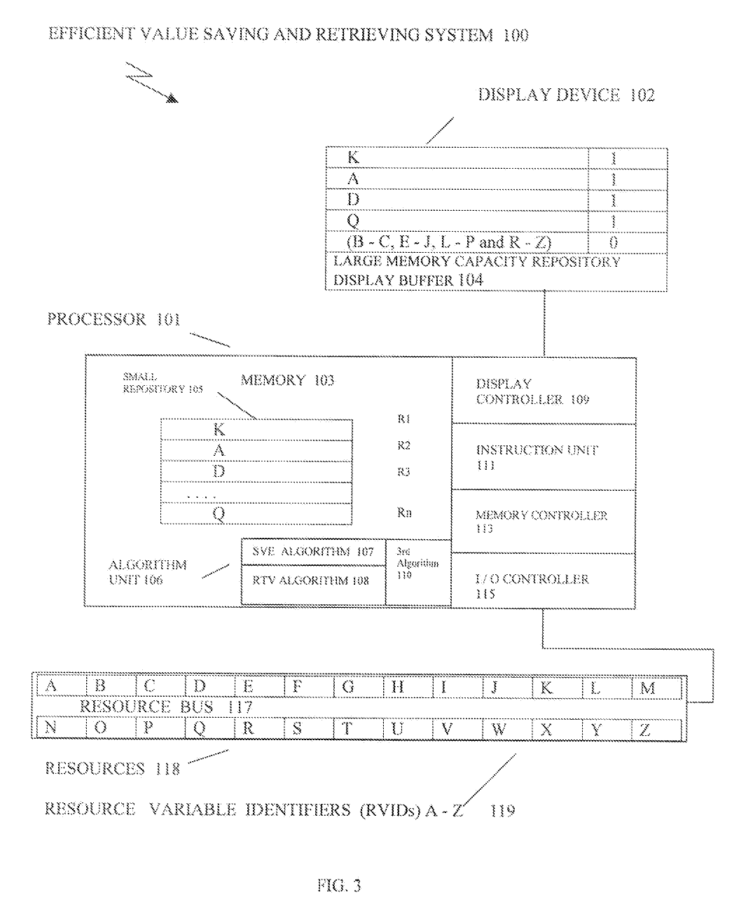

FIG. 3 illustrates the system implementation of the preferred embodiment of efficient Boolean value saving and retrieving using small repository 105.

### DETAILED DESCRIPTION

A preferred embodiment of the invention is described below in detail. The disclosed embodiment is intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote a limitation of quantity, but rather denote the presence of one or more of the referenced item. In addition, the terms “Boolean state values” and “Boolean values” are used interchangeably throughout the disclosure to describe a Boolean value representing an operational state of a resource.

The preferred Boolean embodiment will be understood by referring to FIGS. 1 through 3. A process of saving resource variable identifiers and their Boolean values in operation SVE 10 is illustrated in FIG. 1 and a process of retrieving a return Boolean value in operation RTV 20 is illustrated in FIG. 2; these operations are implemented in the efficient value saving and retrieving system 100, illustrated in FIG. 3.

Referring to FIG. 3, the efficient value saving and retrieving system 100 includes processor 101 having display controller 109, instruction unit 111, input/output controller 115, memory 103 and memory controller 113. A group of resources 118 (which represent either physical or logical resource devices, such as hard drives) designated by resource variable identifiers A through Z 119 are coupled electrically and in communication with input/output controller 115 of processor 101 by way of resource bus 117. Display device 102 is connected to and is in electrical communication with processor 101 by way of display controller 109. Display device 102 includes a visual display where outputs generated by SVE algorithm 107, RTV algorithm 108 or third algorithm 110 are displayed, and where the outputs displayed represent the contents of a large memory capacity repository display buffer 104 which has a repository memory capacity large enough to hold the universe of the plurality of RVIDs inspected along with each Boolean value associated with each of the plurality of RVIDs and where the universe of RVIDs with their normal or non-normal Boolean values can be displayed all at the same time on display device 102. RVIDs found to have non-normal values are obtained and transmitted for display on display device 102 by SVE algorithm 107, RTV algorithm 108 or third algorithm 110 and non-normal Boolean values corresponding to those RVIDs obtained are generated and transmitted for display on display device 102 by SVE algorithm 107, RTV algorithm 108 or third algorithm 110. RVIDs and their Boolean values determined to be normal are generated and transmitted for display on display device 102 by SVE algorithm 107, RTV algorithm 108 or third algorithm 110.

Memory 103 contains small repository 105, having a small relative size and illustrated in FIG. 3. Small repository 105 contains repository entry locations R1 through Rn, where small repository 105 is characterized as being small, as compared to the large memory capacity repository display buffer 104 required to hold each RVID in the known universe of RVIDs A-Z 119 that are inspected by the method and system. (In addition, in a non-Boolean embodiment, the capacity of small repository 105 would have to be increased to hold the non-normal non-Boolean values along with their associated RVIDs). Thus, small repository 105 is smaller in size than all of the possible resources and their associated values to be monitored, where the size of the small repository is measured in terms of memory capacity of repository entry locations R1 through Rn. Small repository 105 is flexible and at any point in time can be contracted or expanded to contain a repository entry location capacity of Rn, where Rn is determined by solving for “n”, based on calculating the sum of the number of RVIDs known to have a non-normal Boolean value. Thus, as illustrated in FIG. 3, representing a point in time, small repository 105 is expanded to repository entry location “Rn”, where:

n=(SUM Number of Known RVIDs with BV Nonnorm); thus

n=(SUM of K+A+D+Q); thus

n=4; thus, in this example at a given point in time, the small repository is expandable to

Rn=R4, (i.e., 4 entry locations accommodating 4 known entries).

Memory 103 also contains algorithm unit 106, where first, second and third algorithms SVE algorithm 107, RTV algorithm 108 and third algorithm 110 respectively reside and are executed by processor 101 and cause processor 101 to perform various operations. SVE algorithm 107 is programmed to perform saving operation SVE 10. RTV algorithm 108 is programmed to perform retrieving operation RTV 20 and third algorithm 110 is programmed to perform other operations including display and network control operations.

Referring to FIG. 1, at start SVE 11 of saving operation SVE 10, repository 105 may or may not have an entry for RVID_{K}. In first obtaining sub operation SVE 12, a first RVID_{K} and its associated value are obtained from a source other than small repository 105 and inspected. First determining sub operation SVE 13 is conducted to determine whether the value of the first RVID_{K} under consideration is normal or non-normal. In the preferred Boolean embodiment, a normal value is always zero (0) and a non-normal value is always one (1). (In a non-Boolean embodiment, the value can be an alphanumeric character or character string). Second determining sub operation SVE 14 is conducted to determine whether an entry exists for the first RVID_{K} under consideration in repository 105, where repository 105 comprises “Rn” distinct entries, as shown by R1 through Rn, where “Rn” is less than or equal to the number of resource variables being tracked in the universe of RVIDs A-Z 119 and each repository entry location holds a given RVID that has a non-normal Boolean value. (In a non-Boolean model the repository also holds the non-normal value associated with the given RVID). Any RVID will appear at most once in the repository.

First determining sub operation SVE 13 determines whether the Boolean value of the first RVID_{K} is normal or non-normal, i.e., zero or one. Second determining sub operation SVE 14 determines whether an entry exists for the first RVID_{K} in small repository 105, when the Boolean state value of the first RVID_{K} is non-normal. A third determining sub operation SVE 15 determines whether an entry exists for the first RVID_{K} in small repository 105, when the Boolean state value of the first RVID_{K} is normal.

If it is determined in the second determining sub operation SVE 14 that the entry does exist for the first RVID_{K} in small repository 105, when the Boolean state value is non-normal, then saving operation SVE 10 proceeds to saving operation (save op) return SVE 18. Or, if the entry does not exist for the first RVID_{K} in small repository 105, when the Boolean state value of the first RVID_{K} is non-normal, then first performing sub operation SVE 16 adds the first RVID_{K} to small repository 105. After the entry is added, saving operation SVE 10 proceeds to save op return SVE 18.

If it is determined in third determining sub operation SVE 15 that the entry does not exist for the first RVID_{K} in small repository 105, when the Boolean state value is normal, then saving operation SVE 10 proceeds to save op return SVE 18. Or, if it is determined that the entry does exist for the first RVID_{K} in small repository 105, when the Boolean state value of RVID_{K} is normal, then second performing sub operation SVE 17 removes the first RVID_{K} from small repository 105, where removing the repository entry of the first RVID_{K} keeps the repository small by eliminating RVIDs that have the normal Boolean value. After the entry is removed, saving operation SVE 10 proceeds to save op return SVE 19. Thus, by literally recording in small repository 105 only the RVIDs that have non-normal Boolean values, the method and system of saving also distinguish and virtually record the RVIDs that have normal Boolean state values; thereby, recording by not recording the distinguished RVIDs with normal Boolean values. Therefore, by design, SVE algorithm 107 keeps track of all of the RVIDs and their Boolean state values, even though only the RVIDs associated with non-normal values need to be recorded in small repository 105 and by design, SVE 17 keeps the repository as small as possible by pruning RVIDs with normal Boolean values. SVE algorithm 107 also knows that the remaining RVIDs, i.e., RVIDs B−C, E−J, L−P and R−Z each have a normal Boolean state value of zero.

Referring to FIG. 2, the method of retrieving operation RTV 20 comprises the following sub operations RVE 21 through RTV 26, performed by RTV algorithm 108: At start RTV 21, repository 105 may or may not have an entry for RVID_{K}. Second obtaining sub operation RTV 22 is conducted to obtain an RVID that is either the same or different than RVID_{K} from a source other than small repository 105. Fourth determining sub operation RTV 23 is conducted to determine whether an entry exists in small repository 105 for RVID_{K}.

If it is determined in fourth determining sub operation RTV 23 that an entry does not exist in small repository 105 RVID_{K}, then third performing sub operation RTV 24 sets a return value to a normal Boolean value and after the set return value is set then, retrieving operation RTV 20 proceeds to retrieving operation (retrieve op) return RTV 26. In the alternative, if it is determined that an entry does exist in small repository 105 for RVID_{K}, then fourth performing sub operation RTV 25 sets a return value to a non-normal Boolean value and after the set return value is set, then retrieving operation RTV 20 proceeds to retrieve op return RTV 26.

After the above described save op return SVE 18 and retrieve op return RTV 26 values have been set, values from saving operation SVE 10 and retrieving operation RTV 20 can be used in third algorithm 110 called to perform additional operations and/or sub operations. For example, third algorithm 110 can cause any of the above operations and sub operations to be repeated or cause set values to be streamed to display device 102 (as illustrated in FIG. 3) or streamed to instruction unit 111, where such data are used to generate instructions to control additional data handling operations in computer data handling event monitoring applications.

Thus, the useful, practical and concrete result of reducing the required memory allocation of small repository 105 is accomplished because by inventive design SVE algorithm 107, RTV algorithm 108 and third algorithm 110 conducting the operations of the efficient saving and retrieving method and system by design cause the memory capacity of small repository 105 to be only as large as the sum of RVIDs with non-normal Boolean values. Also, the memory capacity of small repository 105 is decreased further because SVE algorithm 107, RTV algorithm 108 and third algorithm 110 by design know by default that any RVIDs recorded (i.e., RVIDs K, A, D and Q) each have the non-normal Boolean value of one and each of the remaining RVIDs (i.e., RVIDs B−C, E−J, L−P and R−Z) in the universe of known RVIDs A-Z 119 have the normal Boolean value of zero; therefore, once it is determined by the algorithms whether the Boolean values are either normal or non-normal, it is not required to record any of the Boolean values in small repository 105. In addition, the size of the small repository is kept small by pruning RVIDs with normal Boolean values.

While the disclosure has been described with reference to a preferred Boolean embodiment, it will be understood by those skilled in the art that various changes may be made and equivalents may be substituted for elements thereof without departing from the scope of the disclosure. For example, in a generic sense, a resource variable identifier and its value can be represented by any name or any value. Thus, a resource variable identifier can identify people. “Marty” and “John” and the RVIDs for each person can be characterized as “RVID_{M}” and “RVID_{J}” respectively. If it is known that “John” spends a dollar amount of $18 dollars a month for a certain item and Marty spends $24 dollars a month for the same item, then the value associated with RVID “John” is a value of “$18” and the value associated with RVID “Marty” is “24”.

In addition, many modifications may be made to adapt a particular situation or material to the teachings of the disclosure without departing from the essential scope thereof. For example, the method of saving and retrieving can be carried out by at least polling and/or interrupt operations. Therefore, it is intended that the disclosure not be limited to any one particular embodiment disclosed as the best mode contemplated for carrying out this disclosure, but that the disclosure will include all embodiments falling within the scope of the appended claims.

What is claimed is:

1. A method of saving and retrieving a Boolean value of each one of a plurality of resource variable identifiers using a small repository, where the small repository has a memory capacity that is small compared to a large memory capacity repository that can hold each of the plurality of resource variable identifiers and their associated Boolean values, the method comprising:
performing a saving operation by a first algorithm, where the first algorithm is a saving algorithm including a first set of sub operations of:
obtaining in a first obtaining sub operation a first resource variable identifier of the plurality of resource variable identifiers and the Boolean value of the first resource variable identifier;
determining in a first determining sub operation whether the Boolean value of the first resource variable identifier is one of normal and non-normal and proceeding to one of a second determining sub operation, if the Boolean value of the first resource variable identifier is non-normal and a third determining sub operation, if the Boolean value of the first resource variable identifier is normal;
determining in the second determining sub operation whether an entry exists for the first resource variable identifier in the small repository, when the Boolean value of the first resource variable identifier is non-normal and proceeding to one of a save operation return, if the entry exists for the first resource variable identifier and a first performing sub operation, if the entry does not exist for the first resource variable identifier, where the first performing sub operation adds the entry for the first resource variable identifier in the small repository and proceeds to the save operation return and where at any point in time the memory capacity of the small repository is one of contractible and expandable from repository entry locations R1 through Rn, and where Rn is based on a summation of a number of resource variable identifiers of the plurality of resource variable identifiers known to have a non-normal Boolean value, calculated by
n=(SUM Number of Known RIVDs with BV Nonnorm);
determining in the third determining sub operation whether the entry exists for the first resource variable identifier in the small repository, when the Boolean value is normal and one of proceeding to the save operation return, when the entry does not exist for the first resource variable identifier in the small repository, when the Boolean value of the first resource variable identifier is normal and proceeding to the second performing sub operation, if the entry exists for the first resource variable identifier, when the Boolean value is normal, where the second performing sub operation removes the entry for the first resource variable identifier and proceeds to the save operation return, where removing the entry of the first RVID records the entry of the first RVID by not recording the entry of the first RVID because the entry of the first RVID is distinguished by having a normal Boolean value known by default by at least the first algorithm, and where the first obtaining, the first determining, the second determining, the third determining, the first performing and the second performing can be repeated by the first algorithm, and where the memory capacity of the small repository is based on the number of resource variable identifiers known to have non-normal Boolean values represented by Rn and where the size of the small repository is further reduced because the Boolean value of any resource variable identifier is not required to be saved in the small repository and where the memory capacity of the small repository is small compared to the large memory capacity repository that can hold each of the plurality of resource variable identifiers and their associated Boolean values, and where removing the entry of the first resource variable identifier keeps the memory capacity of the small repository small by eliminating resource variable identifiers that have normal Boolean values; and performing a retrieving operation by a second algorithm, where the second algorithm is a retrieving algorithm including a second set of sub operations of:
obtaining in a second obtaining sub operation a second resource variable identifier from a source other than the small repository, where the second resource variable identifier is one of a different resource variable identifier and the first resource variable identifier;
determining in a fourth determining sub operation whether an entry exists in the small repository for the second resource variable identifier and one of proceeding to a third performing sub operation, if the entry does not exist in the small repository for the second resource variable identifier and proceeding to a fourth performing sub operation if the entry exists for the second resource variable identifier, where the third performing sub operation sets a return value to the normal Boolean value, if the entry does not exist in the small repository for the second resource variable identifier and proceeds to a retrieve operation return, where a fourth performing sub operation sets a return value to the non-normal Boolean value, if the entry exists for the second resource variable identifier and proceeds to the retrieve operation return, where the second obtaining, the fourth determining, the third performing, and the fourth performing can be repeated by the second algorithm, and a third algorithm can stream data to be displayed and to generate instructions.

2. The method according to claim 1, where at least one of the saving algorithm and the retrieving algorithm is programmed to obtain RVIDs and their associated Boolean values by at least one of a polling method and an interrupt method.

3. A system for saving and retrieving a Boolean value of each one of a plurality of resource variable identifiers using a small repository, where the small repository has a memory capacity that is small compared to a large memory capacity repository that can hold each of the plurality of resource variable identifiers and their associated Boolean values, the system comprising:
a processor having a display controller, an instruction unit, an input/output controller, a memory and a memory controller;
a group of resources designated by the plurality of resource variable identifiers in electrical communication with the input/output controller of the processor by way of a resource bus;
a small repository containing repository entry locations, where a number of repository entry locations at any point in time is one of increased and decreased, based on determining a sum of a number of resource variable identifiers of the plurality of resource variable identifiers known to have a non-normal Boolean value represented by:
n=(SUM Number of Known RVIDs with BV Nonnorm); and
an algorithm unit residing in the memory, where the algorithm unit contains a first algorithm, a second algorithm and a third algorithm, where the first algorithm executes a saving operation in the instruction unit in the processor that when executed by the processor causes the processor to perform a first set of sub operations that:
obtain in a first obtaining sub operation a first resource variable identifier of the plurality of resource variable identifiers and the Boolean value of the first resource variable identifier;
determine in a first determining sub operation whether the Boolean value of the first resource variable identifier is one of normal and non-normal and proceeding to one of a second determining sub operation, if the Boolean value of the first resource variable identifier is non-normal and a third determining sub operation, if the Boolean value of the first resource variable identifier is normal;
determine in the second determining sub operation whether an entry exists for the first resource variable identifier in the small repository, when the Boolean value of the first resource variable identifier is non-normal and proceeding to one of a save operation return, if the entry exists for the first resource variable identifier and a first performing sub operation, if the entry does not exist for the first resource variable identifier, where the first performing sub operation adds the entry for the first resource variable identifier in the small repository and proceeds to the save operation return;
determine in the third determining sub operation whether the entry exists for the first resource variable identifier in the small repository, when the Boolean value is normal and one of proceeding to the save operation return, when the entry does not exist for the first resource variable identifier in the small repository, when the Boolean value of the first resource variable identifier is normal and proceeding to the second performing sub operation, if the entry exists for the first resource variable identifier, when the Boolean value is normal, where the second performing sub operation removes the entry for the first resource variable identifier and proceeds to the save operation return, where removing the entry of the first RVID records the entry of the first RVID by not recording the entry of the first RVID because the entry of the first RVID is distinguished by having a normal Boolean value known by default by the first, second and third algorithms, executed by the processor, and where the first obtaining, the first determining, the second determining, the third determining, the first performing and the second performing can be repeated by the first algorithm, and wherein the memory capacity of the small repository is reduced because the Boolean value of any resource variable identifier is not required to be saved in the small repository along with any resource variable identifier associated with any non-normal Boolean value, and where the small repository is small in memory capacity compared to the large memory capacity repository that can hold each of the plurality of resource variable identifiers and their associated Boolean values, and where removing the entry of the first resource variable identifier keeps the memory capacity of the small repository small by eliminating resource variable identifiers that have the normal Boolean values; and
where the second algorithm when executed by the processor causes the processor to perform a second set of sub operations that:
obtain in a second obtaining sub operation a second resource variable identifier from a source other than the small repository, where the second resource variable identifier is one of a different resource variable identifier and the first resource variable identifier;
determine in a fourth determining sub operation whether an entry exists in the small repository for the second resource variable identifier and one of proceeding to a third performing sub operation, if the entry does not exist in the small repository for the second resource variable identifier and proceeding to a fourth performing sub operation if the entry exists for the second resource variable identifier, where the third performing sub operation sets a return value to the normal Boolean value, if the entry does not exist in the small repository for the second resource variable identifier and proceeds to a retrieve operation return, where a fourth performing sub operation sets a return value to the non-normal Boolean value, if the entry exists for the second resource variable identifier and proceeds to the retrieve operation return, where the second obtaining, the fourth determining, the third performing, and the fourth performing can be repeated by the second algorithm, and the third algorithm can stream data to be displayed and to generate instructions.

4. The system according to claim 3, where at least one of the first algorithm and the second algorithm is programmed to obtain RVIDs and their associated Boolean values by at least one of polling and interrupts.
